(19) United States
(12) Patent Application Publication
(10) Pub. No.: US 2026/0131265 A1
(43) Pub. Date: May 14, 2026

(54) BACKWASHING DEVICE FOR FIBROUS FILTRATION APPARATUS AND FIBROUS FILTRATION APPARATUS INCLUDING THE SAME

(71) Applicant: GRENEX Limited, Seoul (KR)

(72) Inventor: CHUNGCHANG KUK, SEOUL (KR)

(21) Appl. No.: 18/947,521

(22) Filed: Nov. 14, 2024

(51) Int. Cl. B01D 29/68; B01D 29/39

(52) U.S. Cl. CPC B01D 29/688; B01D 29/39; B01D 2321/04; B01D 2321/26

(57) ABSTRACT

The present invention relates to a backwashing device for a fibrous filtration apparatus, and the fibrous filtration apparatus including the same, in which a portion of an inner space formed by a suction body and a suction plate in which backwashing is performed is divided, and water or a cleaning agent is supplied to the divided space from the outside and is evenly ejected and applied to a surface of a disk-type filter medium, so that materials, which are not easily removed by water, such as foreign substances and grease attached and fixed to a fiber part of the disk-type filter medium are cleanly removed, and thus backwashing efficiency can be improved.

### BACKGROUND

### 1. Field of the Invention

The present invention relates to a backwashing device for a fibrous filtration apparatus and a fibrous filtration apparatus including the same. More specifically, a portion of a body in which backwashing is performed is divided so that water or a cleaning agent may be injected from the outside, and the injected water or the injected cleaning agent may be ejected and applied to a disk-type filter medium surface and a filter medium support, so that the surface of the disk-type filter medium is configured such that microorganisms generated in the filter medium and the filter medium support which are fixed or to which foreign substances such as grease are stuck may be cleaned by a filtration action. Thus, a backwashing effect can be improved, and management and maintenance of the backwashing device may be easily performed. In this case, since the backwashing is performed in a state in which the water or the cleaning agent is evenly applied to the entire the disk-type filter medium surface and the entire filter medium support or in a state after a certain period of time elapses from the application, a cleaning effect is sufficient to remove foreign substances, grease, and microbial communities or microbial biofilms that are fixed, and thus backwashing efficiency is further increased.

### 2. Discussion of Related Art

Generally, in a fibrous filtration apparatus, a certain amount of inflow raw water such as sewage, wastewater, dirty water, and service water is supplied to a filter tank, and at least one disk-type filter medium is mounted on a rotary shaft so that a filtration operation is performed while the inflow raw water flowing into the filter tank passes through and permeates the disk-type filter medium, and filtered filtration water is discharged to the outside of the filter tank through the rotary shaft. Here, the disk-type filter medium uses a fine fiber material to separate or remove solid substances or floating substances from water or liquid, and accordingly, foreign substances filtered out in this way are stuck to a surface of the disk-type filter medium.

Further, sludge or microbial communities or microbial biofilms are formed on the surface of the filter medium, inside the filter medium, and on a support for supporting the filter medium.

Meanwhile, the disk-type filter medium is equipped with a backwashing device as in Patent Document 1 to 3 below in order to remove attached foreign substances through a filtration operation.

### (Patent Document 1) Korean Patent No. 10-2404899

A cut surface is formed on one surface of a suction plate with respect to a slit, a pattern roller may rotate in place in a seat provided in a thickness portion of the slit in which the cut surface is formed, a portion of the pattern roller protrudes outward from the cut surface while passing through the slit and forms a pattern on a backwashed villus surface, and thus a filtration area of a villus may be increased. Further, the seat is formed to be separated from the slit on the cut surface by a predetermined distance, a filtering area for the backwashing and the villus increases through the seat, and thus filtration efficiency of a fibrous filtration apparatus may be further increased. Further, a pattern in the form of a spline cut by a certain length from a surface of the pattern roller, a pattern in which several annular protrusions are formed on an outer circumference of the pattern roller, a pattern in the form of a spline on the outer circumference, a pattern in which irregularities are repeated in a lattice shape, and the like may be formed.

### (Patent Document 2) Korean Patent No. 10-2183820

This patent document relates to a backwashing suction device for a fibrous filtration apparatus, in which an inclined surface is formed on an edge surface of a suction slit through which a villus escapes, the villus suctioned into the suction slit comes into contact with the inclined surface when a filter disk filter rotates for backwashing, and thus the amount of rotation of the villus may be increased to increase a backwashing effect. Further, since several friction protrusions are formed to protrude from the inclined surface, an effect of removing foreign substances may be further increased through an effect of rubbing and washing the villus on a washing plate while the villus moves over each of the friction protrusions one by one.

### (Patent Document 3) Korean Patent Publication No. 10-2021-0114326

This patent document provides a backwashing suction device for a fibrous filtration apparatus, in which a whipping member having a protrusion is formed inside a suction body, foreign substances may be removed through the same effect as shaking off the foreign substances using inertia generated in in a process of allowing a villus suctioned into the suction body through a slit to collide with the whipping member, a process of allowing the villus to repeatedly collide with the protrusion, and a process of allowing the villus to be wound around the whipping member and then released again, and thus, a backwashing effect for the villus may be increased, and accordingly, a small amount of backwashing water required for the backwashing may be used. In particular, because the whipping member having various width cross-sections is formed on the suction body to face the slit, the backwashing effect may further be increased through the inertia provided when the villus suctioned in a straight line through the slit collides with the whipping member, is wound thereon, and is unwound therefrom.

### RELATED ART DOCUMENTS

### Patent Documents

(Patent Document 1) Korean Patent No. 10-2404899 (Registration Date: 2022.05.30)

(Patent Document 2) Korean Patent No. 10-2183820 (Registration Date: 2020.11.23)

(Patent Document 3) Korean Patent Publication No. 10-2021-0114326 (Publication Date: 2021.09.23)

### SUMMARY OF THE INVENTION

However, the backwashing device according to the related art has the following problems.
(1) The backwashing device according to the related art suctions a fiber part that forms a surface of a disk-type filter medium while removing foreign substances attached to the surface. Accordingly, to increase backwashing efficiency of the disk-type filter medium, a suction pressure that suctions the fiber part should change.
(2) Accordingly, in order to increase the suction pressure, a capacity of a suction means such as a pump should be increased. This may lead to an increase in the overall costs of the fibrous filtration apparatus.
(3) Further, when the suction pressure is increased, a backwashing effect may be increased, but the fiber part may be peeled off and separated from the disk-type filter medium due to this suction pressure. This degrades filtration efficiency of the fibrous filtration apparatus and also shortens a lifetime of the disk-type filter medium, thereby increasing maintenance costs.
(4) Further, in this way, as strong water pressure is applied to the backwashing device, the backwashing device may move without being fixed at a predetermined location or collide with other backwashing devices or other disk-type filter media therearound while moving.
(5) Meanwhile, in the disk-type filter medium, foreign substances that substantially remain after filtration are fixed to the fiber part or grease is stuck to the fiber part, and even when the foreign substances and the like are forcibly removed by suctioning the fiber part using a suction means, the foreign substances are not easily removed, and materials stuck to the fiber part remain. These substances become more fixed over time and cannot be backwashed over time, and as a result, a situation in which the disk-type filter medium should be replaced may occur.
(6) These substances such as the grease reduce filtration efficiency of the fiber part as a filtration time increases through the disk-type filter medium, and, as a result, serves as a factor that prevents the disk-type filter medium from performing a filtration operation.
(7) Further, microbial communities or microbial biofilms are fixed to a surface of the filter medium, an inside of the filter medium, or a filter medium support, increase a filtration time through the disk-type filter medium to degrade the filtration efficiency, or as a result serves as a factor that prevents the disk-type filter medium from performing the filtration operation.

The present invention is directed to providing a backwashing device for a fibrous filtration apparatus, and the fibrous filtration apparatus including the same, in which a portion of an inner space including a suction body and a suction plate in which backwashing is performed is divided, water or a cleaning agent is supplied to the divided space from the outside and is evenly ejected and applied to a surface of a disk-type filter medium and a filter medium support, so that materials, which are not easily removed, such as foreign substances and grease and microbial communities or microbial biofilms attached and fixed to the disk-type filter medium, are cleanly removed, and thus backwashing efficiency can be improved.

The present invention is also directed to providing a backwashing device for a fibrous filtration apparatus, and the fibrous filtration apparatus including the same, in which backwashing is performed in a state in which water or a cleaning agent is ejected and applied to the entire surface of a disk-type filter medium or in a state after a certain period of time elapses from the application, so that a backwashing operation is performed after the fiber part formed on the surface and an inside of the disk-type filter medium and a filter medium support is sufficiently cleaned, and thus backwashing efficiency can be improved, and a lifetime of the backwashing device can be increased.

There is provided a backwashing device for a fibrous filtration apparatus, which backwashes a disk-type filter medium (300) in the fibrous filtration apparatus including a filtration tank (100) that receives inflow raw water, a rotary shaft (200) in which a hollow is formed, which has an outlet formed therein, and which is installed to rotate in place by manual operation or automatic control in the filtration tank (100), and at least one disk-type filter medium (300) that is installed on the rotary shaft (200) at regular intervals, allows the inflow raw water to flow thereinto to perform a filtration operation, and discharges the filtered filtration water to the outside of the filtration tank (100) through the rotary shaft (200), the backwashing device including suction bodies (410) that are directly mounted inside the filtration tank (100) or installed on a mounting bracket mounted inside the filtration tank (100), are installed to perform a backwashing operation on both surfaces of each disk-type filter medium (300), respectively, wherein the suction body (410) is in a shape of a container and has a drainage hole (411) to discharge internal contents to the outside, a suction plate (420) mounted on the suction body (410) to close an inlet portion and having at least one slit (421) to perform the backwashing operation, and a drainage pipe (430) connected to the drainage hole (411) and equipped with a pump (431) to discharge suction water suctioned to the suction plate (420) to the outside of the filtration tank (100), wherein a portion of a space surrounded by the suction body (410) and the suction plate (420) is divided into a water or cleaning solution space (440) over an entire length, and an injection port (441) that forcibly injects water or cleaning solution from the outside and an ejection slit (442) that ejects the water or the cleaning solution injected into the water or cleaning solution space (440) and to face the rotating disk-type filter medium (300) are formed in the water or cleaning solution space (440).

The backwashing device may perform the backwashing operation by suctioning the suction water required for the backwashing operation through the suction plate (420) in a state in which the water or the cleaning solution with which the water or cleaning solution space (440) is filled is ejected and applied to the disk-type filter medium (300) or may perform the backwashing operation after the water or the cleaning solution with which the water or cleaning solution space (440) is filled is ejected and applied to the disk-type filter medium (300) or after a certain period of time elapses from the application.

The ejection slit (442) may be formed at a location where the water or the cleaning solution is ejected to a fiber part of the disk-type filter medium (300) before the fiber part is suctioned into the slit (421).

The present invention includes a fibrous filtration apparatus including the backwashing device for a fibrous filtration apparatus.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view illustrating a fibrous filtration apparatus to which a backwashing device for a fibrous filtration apparatus according to the present invention is applied;

FIG. 2 is a front cross-sectional view illustrating the fibrous filtration apparatus to which the backwashing device for a fibrous filtration apparatus according to the present invention is applied;

FIG. 3 is a side cross-sectional view illustrating the fibrous filtration apparatus to which the backwashing device for a fibrous filtration apparatus according to the present invention is applied;

FIG. 4 is an enlarged view of the part “A” in FIG. 3 to illustrate a configuration of the backwashing device for a fibrous filtration apparatus according to the present invention;

FIG. 5 is a front view illustrating the configuration of the backwashing device for a fibrous filtration apparatus according to the present invention; and

FIG. 6 is a cross-sectional view illustrating an operation of the backwashing device for a fibrous filtration apparatus according to the present invention.

### DETAILED DESCRIPTION OF EXEMPLARY EMBODIMENTS

Embodiments of the present invention will be described in more detail below with reference to the accompanying drawings. Prior to this, terms or words used in the specification and the appended claims should not be interpreted as being limited to usual or dictionary meanings and should be interpreted as meanings and concepts corresponding to the technical spirit of the present invention according to the principle that the inventor may properly define the concepts of the terms in order to describe his/her own invention in the best way.

Thus, configurations illustrated in the embodiments and the drawings described herein are merely most preferable embodiments of the present invention and do not represent all of the technical spirits of the present invention. Thus, it should be understood that various equivalents and modifications that may replace the configurations at a time of the present application.

### Configuration of Fibrous Filtration Apparatus

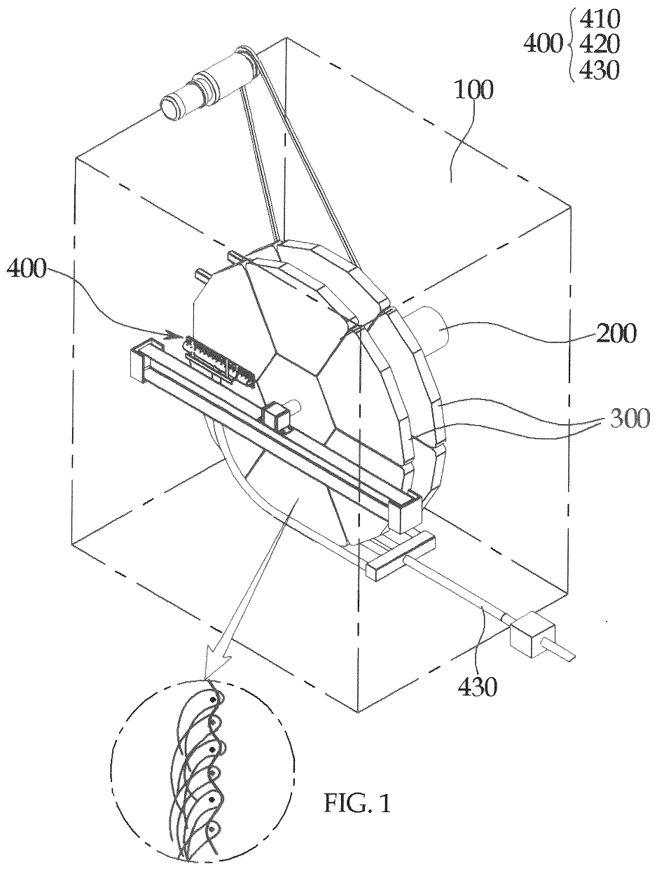

As illustrated in FIGS. 1 to 6, a fibrous filtration apparatus according to the present invention includes a filtration tank 100, a rotary shaft 200, a disk-type filter medium 300, and a backwashing device 400.

In particular, the backwashing device 400 includes a suction body 410 formed in the shape of a container, a suction plate 420 in which at least one slit 421 is formed to close an inlet portion of the suction body 410 and performs backwashing, and a drainage pipe 430 that is connected to the suction body 410 and drains suctioned water required for the backwashing. A portion of an internal space surrounded by the suction body 410 and the suction plate 420 is divided into a water or cleaning solution space 440, water or cleaning solution supplied from the outside is ejected to the disk-type filter medium 300 through the water or cleaning solution space 440, so that foreign substances or oil components that are attached and fixed to the filter medium 300 and microbial communities or microbial biofilms that grow while attached to the filter medium 300 and a filter medium support are cleaned, and thus the backwashing effect may be increased.

In this case, since the water or cleaning solution in the water or cleaning solution space 440 performs cleaning before a fiber part is backwashed, the fixed foreign substances are soaked or microbial communities or microbial biofilms are separated from the filter medium through a cleaning agent and grease is neutralized to easily remove even fixed or oily foreign substances, before the fiber part is suctioned into the suction plate 420, so that the water or the cleaning solution is discharged together with these foreign substances to the outside through the backwashing device, and thus the water or the cleaning solution is prevented from adversely affecting filtration water.

Meanwhile, the water or the cleaning solution is configured to remove the cleaning target through the backwashing while applied to a portion of a surface of the disk-type filter medium 300. However, preferably, the water or the cleaning solution is configured to remove the cleaning target through the backwashing while ejected and applied to the entire surface of the disk-type filter medium 300 or after a certain period of time is elapsed after the application. Thus, a time during which the water or the cleaning solution sufficiently cleans a filter medium portion may be secured, thereby further improving a cleaning effect.

Hereinafter, this configuration will be described in more detail with reference to the accompanying drawings. Here, the present invention is configured to include a fibrous filtration apparatus and a backwashing device. For convenience of description, the backwashing device will be described together while describing the fibrous filtration apparatus. Further, hereinafter, “inflow raw water” means filtration targets such as sewage, wastewater, dirty water, and service water.

### A. Filtration Tank

As illustrated in FIGS. 1 to 3, the filtration tank 100 receives a certain amount of inflow raw water from the outside, stores the inflow raw water, continuously receives the inflow raw water as much as the amount of filtration through the disk-type filter medium 300, which will be described below, and maintains a constant water level. A capacity of the filtration tank 100 for accommodating the inflow raw water is determined in consideration of a capacity of the disk-type filter medium 300 through which the cleaning target is filtered.

### B. Rotary Shaft

As illustrated in FIGS. 1 to 4, the rotary shaft 200 is mounted inside the filtration tank 100 such that both ends thereof may rotate in place. In this case, the rotary shaft 200 is manufactured in the form of a hollow tube and allows the filtration water filtered through the disk-type filter medium 300, which is installed outside the rotary shaft 200 and will be described below, to flow into the rotary shaft 200 and to be discharged to the outside of the filtration tank 100.

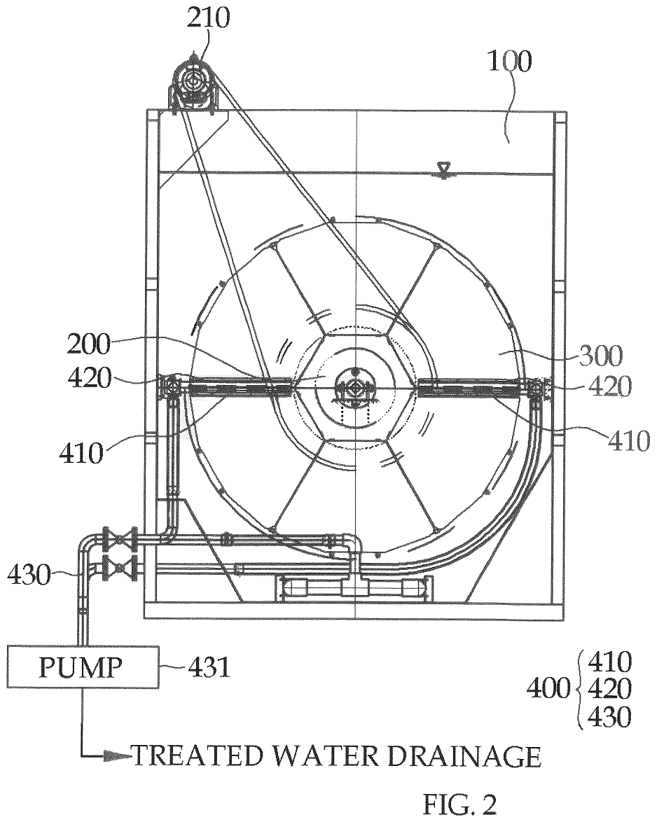

Further, as illustrated in FIG. 2, the rotary shaft 200 is installed to rotate manually or automatically through an actuator 210 such as a motor installed in the filtration tank 100 so as not to be in contact with the inflow raw water.

### C. Disk-Type Filter Medium

As illustrated in FIGS. 1 to 4, the disk-type filter medium 300 refers to a filter medium 300 formed in a disk shape. In this case, the disk-type filter medium 300 is assembled by inserting the rotary shaft 200 in a middle portion thereof, the disk-type filter medium 300 and the rotary shaft 200 are assembled such that an inside of the disk-type filter medium 300 and an inside of the rotary shaft 200 communicate with each other, and thus the filtration water filtered while permeating from the outside to the inside of the disk-type filter medium 300 may be discharged to the outside of the filtration tank 100 through the inside of the rotary shaft 200.

Meanwhile, as illustrated in FIG. 2, it is preferable that the disk-type filter medium 300 include several sectors divided in a trapezoidal shape, and thus the disk-type filter medium 300 may be easily assembled with the rotary shaft 200 and may be easily maintained. Further, each of the sectors includes a frame having a predetermined thickness, and a surface of the frame is configured like a fiber so that a filtration operation may be performed while the inflow raw water passes therethrough. The disk-type filter medium 300 may be manufactured by a conventional technology used in the related field to which the present invention pertains.

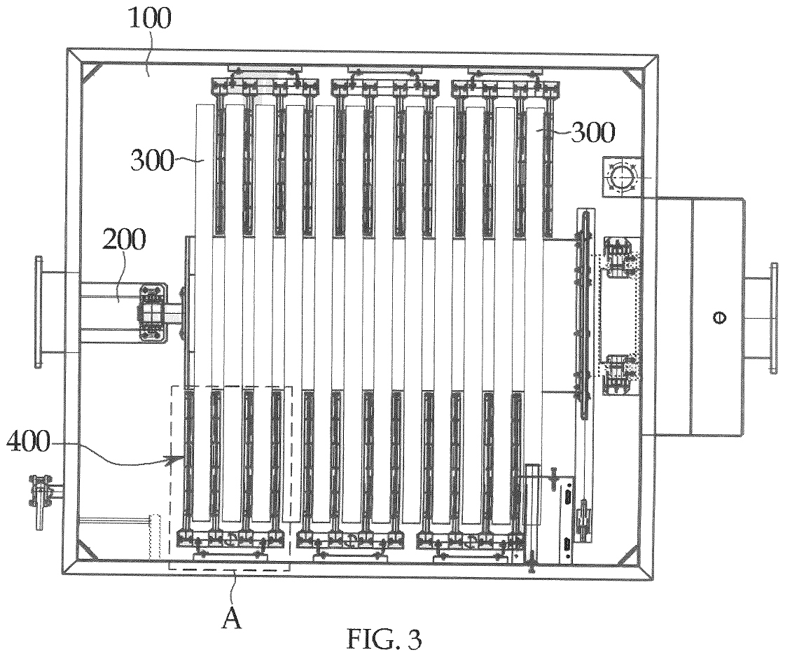

Further, in a preferred embodiment of the present invention, as illustrated in FIGS. 1 and 3, the disk-type filter medium 300 is mounted on the rotary shaft 200 to have a predetermined interval between two adjacent ones thereof, so that not only the filtration operation may be performed on both surfaces of the disk-type filter medium 300 but also a space between the two adjacent disk-type filter media 300 is used for mounting the backwashing device 300, which will be described below.

Here, the filter medium support refers to a structure for installing the filter medium.

### D. Backwashing Device

As illustrated in FIGS. 1 to 5, the backwashing devices 400 are installed on both surfaces of the disk-type filter medium 300, respectively. In this case, each of the backwashing devices 400 is mounted to extend toward a center from an edge of the disk-type filter medium 300 while immersed in the inflow raw water.

As illustrated in FIGS. 3 to 5, the backwashing device 400 includes a suction body 410, a suction plate 420, and a drainage pipe 430. Further, the backwashing device 400 includes a water or cleaning solution space 440 that is formed by the suction body 410 and the suction plate 420 and thus divides a portion of a space in which a backwashing operation is performed.

### 1. Suction Body

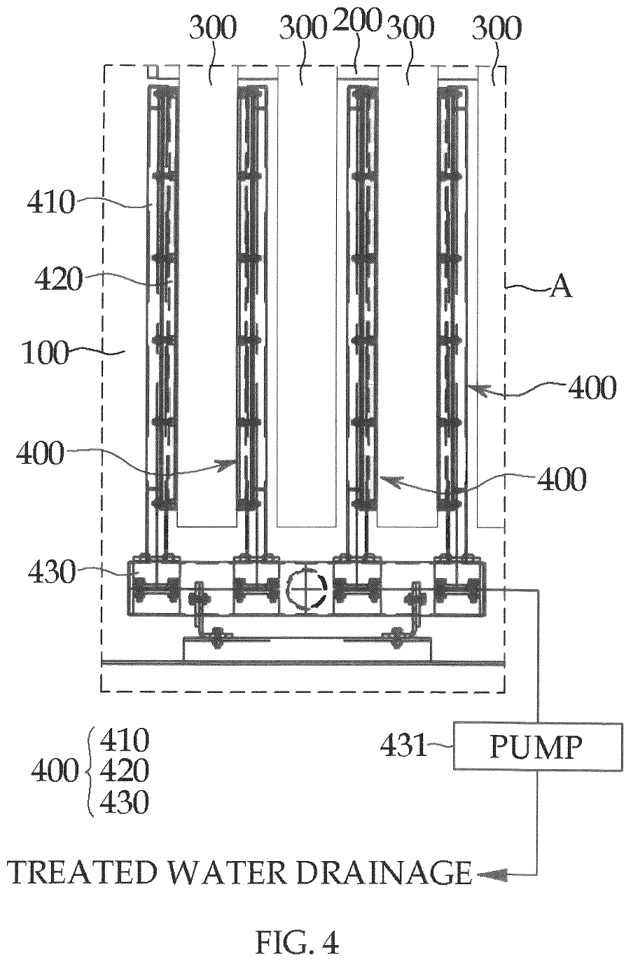

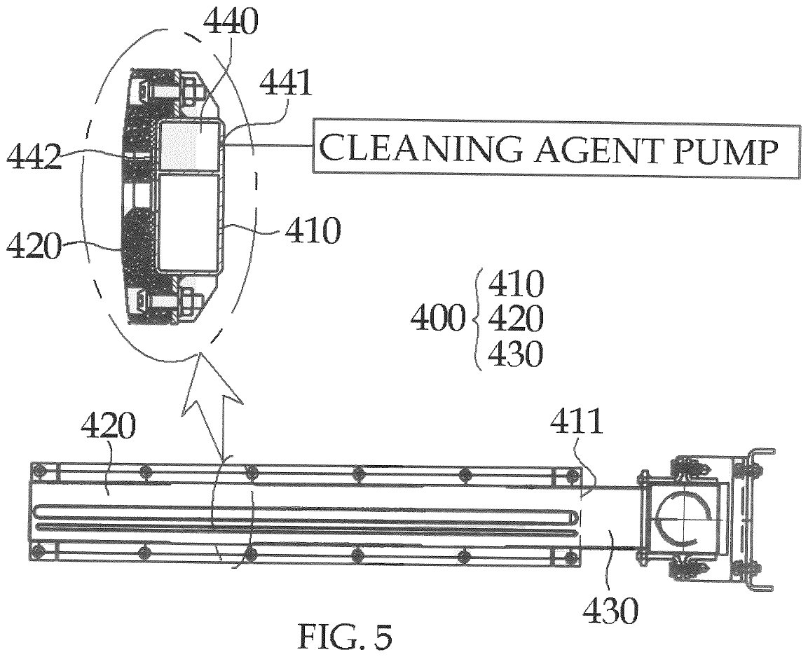

As illustrated in FIGS. 4 and 5, the suction body 410 is directly mounted on the filtration tank 100 or mounted to be hung on to a bracket mounted on the filtration tank 100. The drawings exemplarily illustrate a state in which the drainage pipe 430, which will be described below, is fixed in the filtration tank 100 through the bracket or the like, and one end of the suction body 410 is coupled to the drainage pipe 430 to communicate with each other.

As illustrated in FIG. 5, the suction body 410 is formed in the shape of a long container, and a length of the suction body 410 is formed to reach the rotary shaft 300 from an edge of the disk-type filter medium 300.

As illustrated in FIG. 5, the suction body 410 is closed by mounting the suction plate 420 on an open inlet portion.

### 2. Suction Plate

As illustrated in FIGS. 4 and 5, the suction plate 420 is a plate that closes an open surface of the suction body 410, and at least one slit 421 is formed on one surface thereof to extend in a longitudinal direction to communicate with the suction body 410. In this case, as a pump 431, which will be described below, is driven to discharge suction water suctioned into the suction body 410 to the outside of the filtration tank 100, foreign substances or microbial communities and microbial biofilms stuck to the fiber part are removed through the slit 421 while the fiber part of the disk-type filter medium 300 facing the suction plate 420 is suctioned into the suction body 410 through the slit 421.

In a preferred embodiment of the present invention, those skilled in the art to which the present invention belongs may easily understand that the number, a width, and a cross-sectional shape of the slits 421 may be variously configured to increase a foreign substance removing effect while the fiber part is easily suctioned.

### 3. Drainage Pipe

As illustrated in FIGS. 1 to 4, the drainage pipe 430 may connect the plurality of suction bodies 410 and may perform the backwashing by allowing the suction water to flow into the suction body 410 through the slit 421 of the suction plate 420 using a pressure generated as the suction water filled in the suction body 410 is discharged to the outside of the filtration tank 100 by driving the pump 431 mounted outside the filtration tank 100.

Meanwhile, in a preferred embodiment of the present invention, as illustrated in FIGS. 3 and 4, it is preferable that, as the drainage pipes 430 are installed on both surfaces of the disk-type filter medium 300, a predetermined number of backwashing devices 400 are grouped into one unit for the backwashing device 400 corresponding to the drainage of the disk-type filter medium 300, and the drainage pipes 430 are formed for the one unit. This is to distribute a diameter and an arrangement space and stably discharge the filtration water because the diameter is too great and the arrangement space also increases when the filtration water is discharged through the one drainage pipe 430 when the number of backwashing devices 400 is too great.

Further, in a preferred embodiment of the present invention, as illustrated in FIGS. 3 to 5, the drainage pipe 430 may be connected to one end of the backwashing device 400. However, although not illustrated in the drawings, the backwashing device 400 and the drainage pipe 430 are connected through a drainage hole formed at a middle portion of the suction body 410 constituting the backwashing device 400 to stably perform a drainage operation. This is to ensure that a pressure suctioned for the backwashing through the pump 431 is spread from a central portion to both sides of the suction body 410, thereby achieving a better backwashing effect.

### 4. Water or Cleaning Solution Space

As illustrated in FIGS. 4 and 5, the water or cleaning solution space 440 is formed by dividing a portion of a space which is surrounded by the suction body 410 and the suction plate 420 and in which the backwashing operation is substantially performed.

In this case, as illustrated in FIGS. 4 and 5, an injection port 441 is formed in the water or cleaning solution space 440. The injection port 441 is configured to receive the water or the cleaning solution from the outside of the filtration tank 100, and the water or the cleaning solution may be forcibly supplied to the injection port 441 through a supply pipe having a pump or the like and may be stored in the water or cleaning solution space 440.

Further, as illustrated in FIGS. 4 and 5, an ejection slit 552 is formed in the water or cleaning solution space 440 to eject the water or the cleaning solution toward the disk-type filter medium 300. In this case, it is preferable that the ejection slit 442 is formed lengthwise in parallel to the slit 421 in the suction plate 420, and thus the water or the cleaning solution ejected from the ejection slit 442 may be entirely ejected in a radial direction of the disk-type filter medium 300.

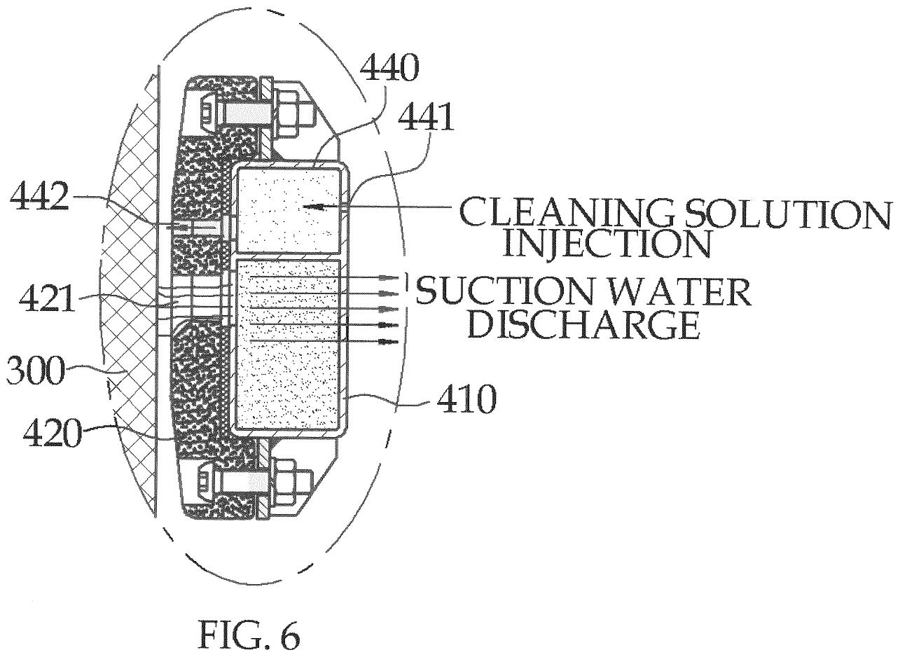

As illustrated in FIG. 6, in a washing device according to the present invention, when it is assumed that the disk-type filter medium 300 rotates downward, the water or the cleaning solution with which the water or cleaning solution space 440 is filled is ejected to the disk-type filter medium 300 to clean a filter medium portion. Next, the backwashing operation of the filter medium may be performed while suctioning the filter medium cleaned using the water or the cleaning agent in the slit 421 and suctioning foreign substances, grease, microbial communities and microbial biofilms, and the like stuck to the filter medium together with the water or the cleaning solution that is ejected.

In a preferred embodiment of the present invention, the washing device is controlled to remove foreign substances through the backwashing device in a state in which the backwashing device does not operate and only the disk-type filter medium 300 rotates in place and in a state in which the water or the cleaning solution is ejected and the water or the cleaning solution is evenly dispersed and applied to the entire surface of the disk-type filter medium 300 or to remove foreign substances through the backwashing device after a certain period of time elapses in a state in which the water or the cleaning solution is evenly dispersed and applied. Thus, foreign substances and grease stuck to the disk-type filter medium and microbial communities or microbiological films in the filter medium and the filter medium support are sufficiently cleaned using the water or the cleaning solution, and thus a cleaning effect can be further improved.

As described above, according to the present invention, the water or cleaning solution space may be provided in the backwashing device, and the water or the cleaning solution with which the water or cleaning solution space is filed may be ejected to the surface of the disk-type filter medium to clean the fiber part. Thus, foreign substances and grease and microbial communities and microbial biofilms that are attached or stuck to the fiber part are removed, and thus a backwashing effect can be further improved.

A backwashing device for a fibrous filtration apparatus and the fibrous filtration apparatus including the same according to the present invention have the following effects.
(1) A portion of a space formed by a suction body and a suction plate is divided so that water or cleaning solution may be supplied from the outside and ejected to a disk-type filter medium. Thus, foreign substances or grease components that are attached and fixed to the filter medium and even microbial communities or microbial biofilms that grow while being attached to the filter medium and a filter medium support may be cleanly removed, thereby improving backwashing efficiency.
(2) In this case, a control is made to perform a backwashing operation after water or cleaning solution is ejected to perform cleaning, and thus efficiency of removing foreign substances or grease components and microbial communities or microbial biofilms that are fixed while the water or the cleaning solution does not adversely affect filtration water may be increased.
(3) In particular, a backwashing operation is performed in a state in which water or cleaning solution is ejected and evenly applied to an entire disk-type filter medium and a filter medium support or in a state in which a cleaning operation is sufficiently performed after a certain period of time elapses from the application. Thus, a cleaning effect of a fiber part of the disk-type filter medium can be further enhanced, and as a result, a backwashing effect can be improved.

What is claimed is:

1. A backwashing device for a fibrous filtration apparatus, which backwashes a surface of a disk-type filter medium (300) in the fibrous filtration apparatus including a filtration tank (100) configured to receive inflow raw water, a rotary shaft (200) in which a hollow is formed, which has an outlet formed therein, and which is installed to rotate in place by manual operation or automatic control in the filtration tank (100), and at least one disk-type filter medium (300) installed on the rotary shaft (200) at regular intervals, configured to allow the inflow raw water to flow thereinto to perform a filtration operation, and configured to discharge the filtered filtration water to the outside of the filtration tank (100) through the rotary shaft (200), the backwashing device comprising:
suction bodies (410) that are directly mounted inside the filtration tank (100) or installed on a mounting bracket mounted inside the filtration tank (100), are installed to perform a backwashing operation on both surfaces of each disk-type filter medium (300), respectively, wherein the suction body (410) is in a shape of a container and has a drainage hole (411) to discharge internal contents to the outside;
a suction plate (420) mounted on the suction body (410) to close an inlet portion and having at least one slit (421) to perform the backwashing operation; and
a drainage pipe (430) connected to the drainage hole (411) and equipped with a pump (431) to discharge suction water suctioned to the suction plate (420) to the outside of the filtration tank (100),
wherein a portion of a space surrounded by the suction body (410) and the suction plate (420) is divided into a water or cleaning solution space (440) over an entire length, and
an injection port (441) configured to forcibly inject water or cleaning solution from the outside and an ejection slit (442) configured to eject the water or the cleaning solution injected into the water or cleaning solution space (440) and to face the rotating disk-type filter medium (300) are formed in the water or cleaning solution space (440).

2. The backwashing device of claim 1, wherein the backwashing device is configured to:
perform the backwashing operation by suctioning the suction water required for the backwashing operation through the suction plate (420) in a state in which the water or the cleaning solution with which the water or cleaning solution space (440) is filled is ejected and applied to the disk-type filter medium (300); or
perform the backwashing operation after the water or the cleaning solution with which the water or cleaning solution space (440) is filled is ejected and applied to the disk-type filter medium (300) or in a state after a certain period of time elapses from the application.

3. The backwashing device of claim 1, wherein the ejection slit (442) is formed at a location where the water or the cleaning solution is ejected to a fiber part of the disk-type filter medium (300) before the fiber part is suctioned into the slit (421).

4. A fibrous filtration apparatus comprising the backwashing device for a fibrous filtration apparatus according to claim 1.

5. A fibrous filtration apparatus comprising the backwashing device for a fibrous filtration apparatus according to claim 2.

6. A fibrous filtration apparatus comprising the backwashing device for a fibrous filtration apparatus according to claims 3.
